(19) United States
(12) Patent Application Publication
(10) Pub. No.: US 2005/0247347 A1
(43) Pub. Date: Nov. 10, 2005

(54) Plaster guard for recessed mounting

(76) Inventor: Gerald J. McNerney, Carmel, IN (US)

Correspondence Address: BAKER & DANIELS LLP, 300 NORTH MERIDIAN STREET, SUITE 2700, INDIANAPOLIS, IN, 46204, US

(21) Appl. No.: 10/839,361

(22) Filed: May 5, 2004

(51) Int. Cl. F16L 5/00

(52) U.S. Cl. 137/360

(57) ABSTRACT

A plaster guard configured to define a recess within a wall around a pipe nipple for the subsequent recessed mounting of a fluid delivery device.

### BACKGROUND AND SUMMARY OF THE INVENTION

The present invention relates to a plaster guard and, more particularly, to a plaster guard configured to be removably coupled around a pipe nipple for defining a recess within a wall for the subsequent recessed mounting of a fluid delivery device.

Plaster guards are known in the art and are often used to protect a wall mounted valve during installation of the surrounding wall and to insure the proper spatial relationship between the wall and the valve. More particularly, the plaster guard may include a planar base section having mounting holes for receiving fasteners which engage the valve fitting and a tubular section which receives the valve body. The plaster guard remains mounted with the valve during plastering and finishing of the wall. The wall is typically plastered flush with the planar base section of the plaster guard. After the wall is finished, the fasteners are removed and the plaster guard is discarded. An escutcheon is then mounted over the hole in the plaster wall formed by the plaster guard and the faucet valve handle is mounted onto the valve to complete the installation.

The above-detailed conventional plaster guards have structures specifically adapted for direct coupling to various components of a valve. As such, these plaster guards are not configured for use with a plumbing rough-in including a conventional pipe nipple positioned for the subsequent recessed mounting of a fluid delivery device.

Such a fluid delivery device may comprise a spray head assembly including a swivel mount permitting at least a portion of the spray head assembly to be hidden behind the wall of a tub or shower installation. In other words, the spray head assembly is fluidly coupled to a conventional pipe nipple recessed within a wall. Details of such a spray head assembly are disclosed in co-pending U.S. patent application Ser. No. 10/784,022, filed Feb. 20, 2004, the disclosure of which is expressly incorporated by reference herein.

During the installation of such a recessed spray head, the surrounding wall is finished around a plumbing rough-in including a pipe nipple. The plaster guard of the present invention insures the proper spatial relationship between the finished wall and the pipe nipple by defining a properly sized receiving recess within the finished wall around the pipe nipple. More particularly, the plaster guard is removed from the finished wall thereby defining a receiving recess in which a spray head is subsequently inserted. The spray head is then fluidly coupled to the pipe nipple.

As noted above, the plaster guard of the present invention is configured to define a receiving recess within a wall around a pipe nipple. An illustrative embodiment of the plaster guard comprises a tubular body portion including an outer wall extending axially between a front end and a rear end and defining a central opening configured to receive the pipe nipple. A coupler is supported by the outer wall and is configured to removably support the body portion around the pipe nipple.

In one illustrative embodiment, the coupler includes a plurality of arms positioned radially inwardly from the outer wall. Each arm includes a retaining portion configured to engage a cap supported by an end of the pipe nipple and thereby prevent axial movement of the body portion in a direction from the rear end toward the front end. Illustratively, the retaining portion includes a stop surface facing axially toward the front end and an inclined guide surface facing toward the rear end. The inclined guide surface is configured to be contacted by the cap of the pipe nipple and force the arms radially outwardly when the central opening receives the pipe nipple and the tubular body portion is moved axially in a direction from the front end toward the rear end.

In a further illustrative embodiment, the coupler includes a receiving member having an internally threaded receiving bore configured to couple to external threads supported on an end of the pipe nipple. Further illustratively, the coupler includes an end wall covering an end of the receiving bore and defining a cap for the pipe nipple.

In another illustrative embodiment, the coupler includes a mounting bracket supported by the outer wall and positioned proximate the rear end of the outer wall. The mounting bracket is configured to be fixed to a stringer positioned behind the pipe nipple.

The present invention further includes a method of forming a receiving recess within a wall surrounding a pipe nipple, the method comprising the steps of providing a pipe nipple having an end and a longitudinal axis, coupling a plaster guard around the pipe nipple, finishing a wall around the plaster guard, and uncoupling the plaster guard from around the pipe nipple.

Illustratively, the method further comprises, prior to the coupling step, the steps of substantially aligning the plaster guard about the longitudinal axis of the pipe nipple, and moving the plaster guard axially in a direction toward the pipe nipple.

The method further illustratively comprises the step of moving the plaster guard axially in a direction away from the pipe nipple, thereby forming a receiving recess within the wall.

The method further illustratively comprises the steps of inserting a fluid delivery device within the receiving recess, and coupling the fluid delivery device to the pipe nipple. Illustratively, the fluid delivery device comprises a spray head supported by a swivel mount.

Additional features and advantages of the present invention will become apparent to those skilled in the art upon consideration of the following detailed description of the presently perceived best mode of carrying out the invention.

### BRIEF DESCRIPTION OF THE DRAWINGS

The detailed description of the drawings particularly refers to the accompanying figures in which:

FIG. 1 is a front perspective view of a first illustrative embodiment plaster guard of the present invention;

FIG. 2 is a rear perspective view of the plaster guard of FIG. 1, showing a portion of a conventional pipe nipple supporting an end cap and configured to be removably coupled to the plaster guard;

FIG. 3 is a front plan view of the plaster guard of FIG. 1;

FIG. 4 is a cross-sectional view taken along line 4-4 of FIG. 3;

FIG. 5 is a cross-sectional view similar to FIG. 4, illustrating the plaster guard removably coupled to a conventional pipe nipple supporting an end cap;

FIG. 6 is a cross-sectional view similar to FIG. 5, illustrating the plaster guard moved axially toward the front end from the position in FIG. 5 and showing engagement between the retaining arms and the end cap;

FIG. 7 is a front perspective view of a second illustrative embodiment plaster guard of the present invention;

FIG. 8 is a rear perspective view of the plaster guard of FIG. 7, showing a portion of a conventional pipe nipple having an end supporting external threads and configured to be removably coupled to the plaster guard;

FIG. 9 is a front plan view of the plaster guard of FIG. 7;

FIG. 10 is a cross-sectional view taken along line 10-10 of FIG. 9;

FIG. 11 is a cross-sectional view similar to FIG. 10, illustrating the plaster guard removably coupled to a conventional pipe nipple;

FIG. 12 is a front perspective view of a third illustrative embodiment plaster guard of the present invention;

FIG. 13 is a rear perspective view of the plaster guard of FIG. 12, showing a portion of a conventional pipe nipple configured to be removably coupled to the plaster guard, and a conventional end cap configured to be threadably received on an end of the pipe nipple;

FIG. 14 is a front plan view of the plaster guard of FIG. 12;

FIG. 15 is a cross-sectional view taken along line 15-15 of FIG. 14;

FIG. 16 is a front plan view of the plaster guard of FIG. 12, illustrating the plaster guard as removably coupled to a conventional stringer; and

FIG. 17 is a cross-sectional view taken along line 17-17 of FIG. 16.

### DETAILED DESCRIPTION OF THE DRAWINGS

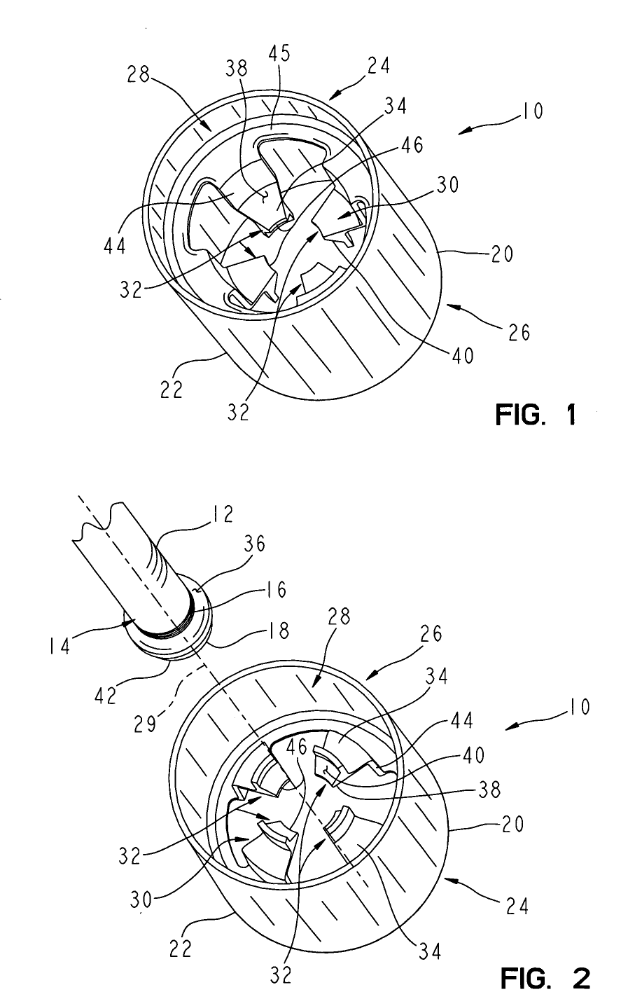

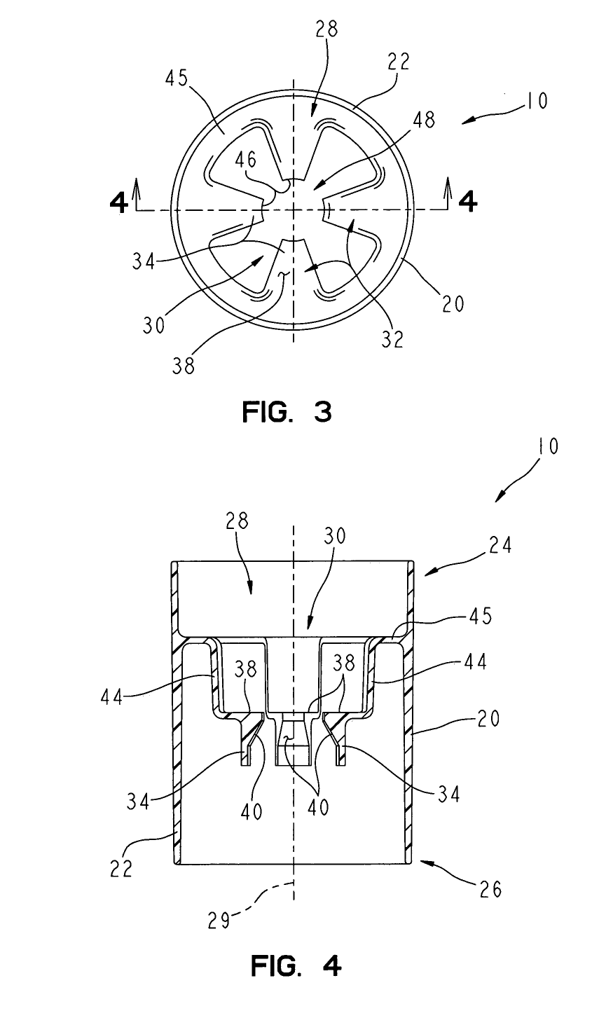

Referring initially to FIGS. 1-4 of the drawings, an illustrative embodiment plaster guard 10 of the present invention is configured to releasably couple with a conventional pipe nipple 12. The pipe nipple 12 includes an end 14 supporting a plurality of external or male threads 16. A conventional end cap 18 is threadably coupled with the external threads 16 of the pipe nipple 12. The plaster guard 10 includes a tubular body portion 20 having a cylindrical outer wall 22 extending axially between a front end 24 and a rear end 26. The outer wall 22 is illustratively shaped and sized to create a receiving recess of the proper dimensions for the receipt of a fluid delivery device, as detailed hereinbelow. The outer wall 22 defines a central opening 28 defining a longitudinal axis 29 and configured to receive the pipe nipple 12. A coupler 30 is supported by the outer wall 22 and is configured to releasably couple the body portion 20 to the pipe nipple 12.

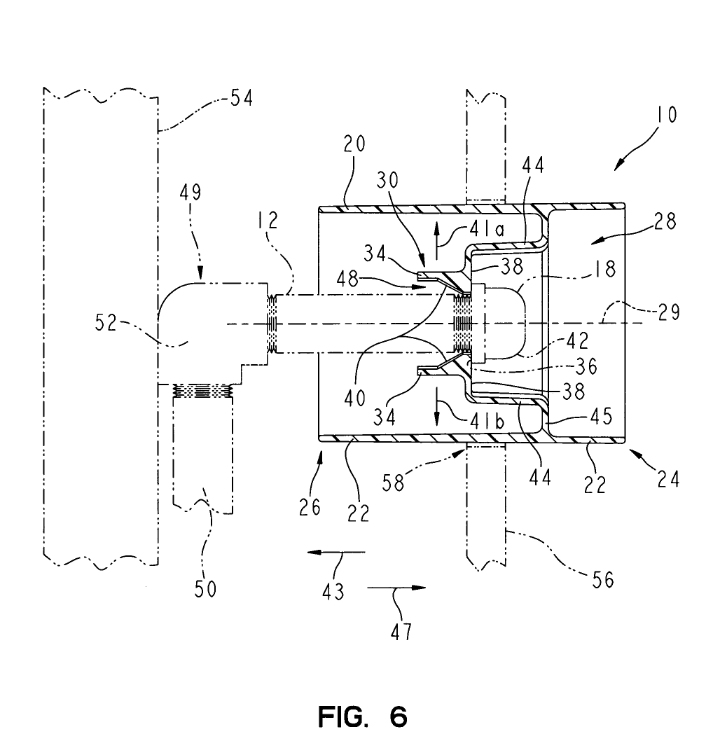

In the illustrative embodiment of FIGS. 1-6, the coupler 30 includes a plurality of retaining arms 32 positioned radially inwardly from the outer wall 22. Each arm 32 includes a retaining portion 34 configured to engage a rear surface 36 of the end cap 18 supported by the pipe nipple 12 (FIG. 6). The retaining portion 34 includes a retaining or stop surface 38 facing axially toward the front end 24 and an inclined guide surface 40 facing toward the rear end 26 of the outer wall 22. The inclined guide surface 40 is configured to be contacted by a front surface 42 of the end cap 18 in order to force the arms 32 radially outwardly (as shown by arrows 41a and 41b in FIG. 6) when the central opening 28 receives the pipe nipple 12 and the tubular body portion 20 is moved axially in a direction from the front end 24 toward the rear end 26 (as shown by arrow 43 in FIG. 6).

More particularly, the arms 32 include support portions 44 which bias the retaining portions 34 radially inwardly toward the longitudinal axis 29. An annular support lip 45 is concentrically received within the central opening 28 and couples the arms 32 to the outer wall 22. The support lip 45 supports the support portion 44 of each arm 32 in radially spaced relation to the outer wall 22. Each retaining portion 34 includes an arcuate notch 46, positioned such that the plurality of arcuate notches 46 collectively define a receiving bore 48 configured to slidably receive the pipe nipple 12. As the end cap 18 is passed through the receiving bore 48, the front surface 42 of the end cap 18 forces the retaining portions 34 radially outwardly by acting against the radially inwardly biasing force of the support portions 44. Once the end cap 18 has passed through the receiving bore 48, removal of the plaster guard 10 from the pipe nipple 12 in the direction toward the front end 24 (as shown by arrow 47 in FIG. 6) is prevented by engagement between the stop surfaces 38 of the arms 32 and the rear surface 36 of the end cap 18. As such, the plaster guard 10 is “snap-fit” over the pipe nipple 12 and the end cap 18.

The plaster guard 10 is illustratively formed of a thermoplastic material and all parts of the structure are integral and formed in a single molding operation. However, it should be appreciated that the plaster guard 10 may be formed of materials other than molded thermoplastic. While the outer wall 22 is illustrated as being cylindrical, other shapes, as well as dimensions, may be utilized depending upon the particular fluid delivery device mounted in the receiving recess ultimately formed by the plaster guard 10. Further, the dimensions of the retaining arms 32 may be specified based upon the particular dimensions of the pipe nipple 12 and the end cap 18 to which the plaster guard 10 is to be coupled.

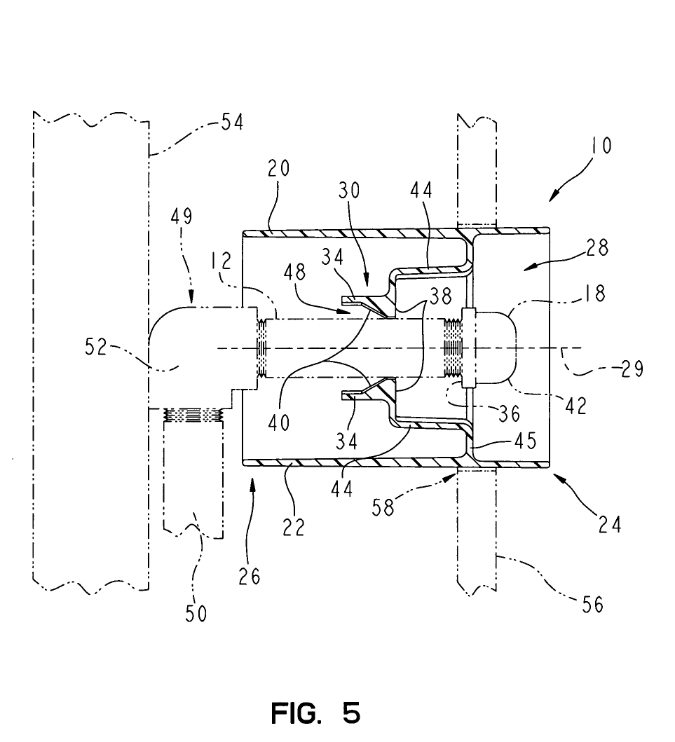

Turning to FIGS. 5 and 6, in use a plumber will install a plumbing rough-in 49 including a water supply conduit 50 connected to an elbow or “drop L” 52 which, in turn, is connected to conventional pipe nipple 12. The rough-in 49 is positioned adjacent, and is usually coupled to, a support or stringer 54, typically a wood stud of an unfinished wall 56. The pipe nipple 12 may be sealed or capped by end cap 18. The plaster guard 10 is then generally aligned axially with the pipe nipple 12 along the longitudinal axis 29. The plaster guard 10 is next moved axially in a direction from the front end 24 to the rear end 26 such that the front surface 42 of the end cap 18 contacts the inclined guide surfaces 40 and thereby forces the arms 32 radially outwardly. The end cap 18 passes through the receiving bore 48 until the rear surface 36 passes axially beyond the stop surfaces 38 of the retaining arms 32. At this point, the retaining portions 34 releasably secure the plaster guard 10 from removal in the direction toward the front end 24 (as shown by arrow 47 in FIG. 6). Movement of the plaster guard 10 in the direction toward the rear end 26 (as shown by arrow 43 in FIG. 6) is prevented by the plumbing rough-in 49.

Next, the wall 56 is finished around the plaster guard 10. More particularly, the wall 56 may be mounted in position using conventional dry wall installation methods. An opening is provided for the plaster guard 10 which is generally the size and shape of the body portion 20 of the plaster guard 10. Dry wall compound is applied to the wall 56, followed by tile, as applicable, in a manner surrounding the outer wall 22 of plaster guard 10. Once the wall 56 is finished, the plaster guard 10 is removed by manually forcing the arms 32 radially outwardly (as shown by arrows 41a and 41b in FIG. 6) and pulling the plaster guard 10 in an axial direction from the rear end 26 to the front end 24 (as shown by arrow 47 in FIG. 6). As such, the retaining portions 34 pass over the end cap 18 thereby uncoupling the plaster guard 10 from the pipe nipple 12. Once removed, the receiving recess 58 of the proper size and shape is formed within the wall 56 for the receipt of the fluid delivery device (not shown), such as the recess mounted spray head detailed in co-pending U.S. patent application Ser. No. 10/784,022, filed Feb. 20, 2004, the disclosure of which is expressly incorporated by reference herein. The fluid delivery device is simply positioned within the recess 58 after the end cap 18 has been removed and then fluidly coupled to the pipe nipple 12.

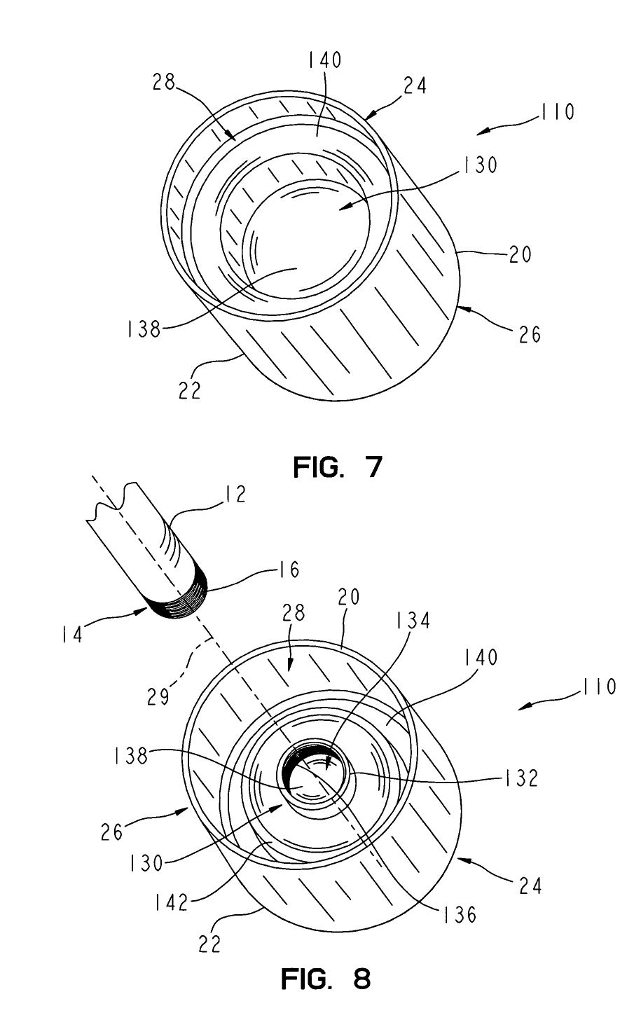

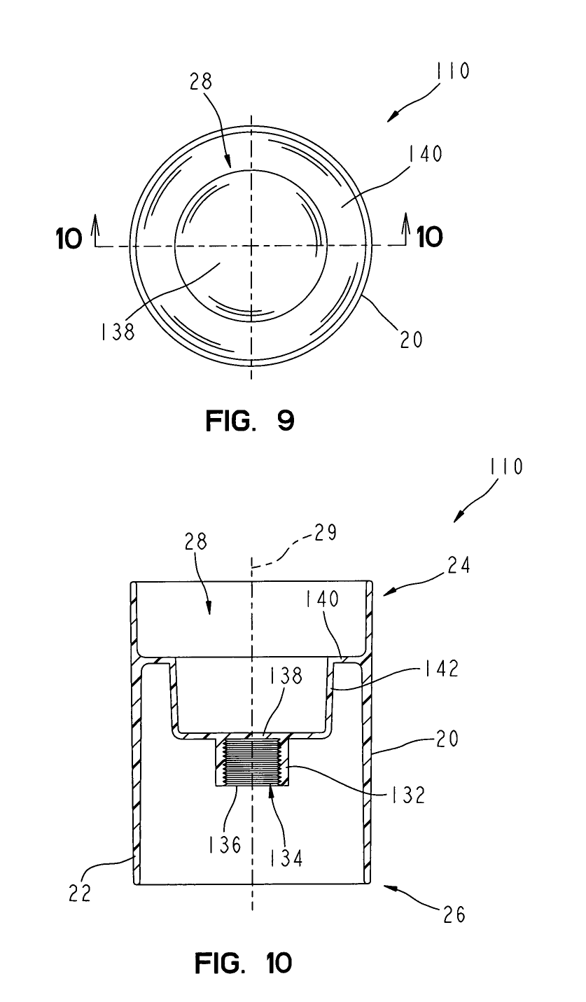

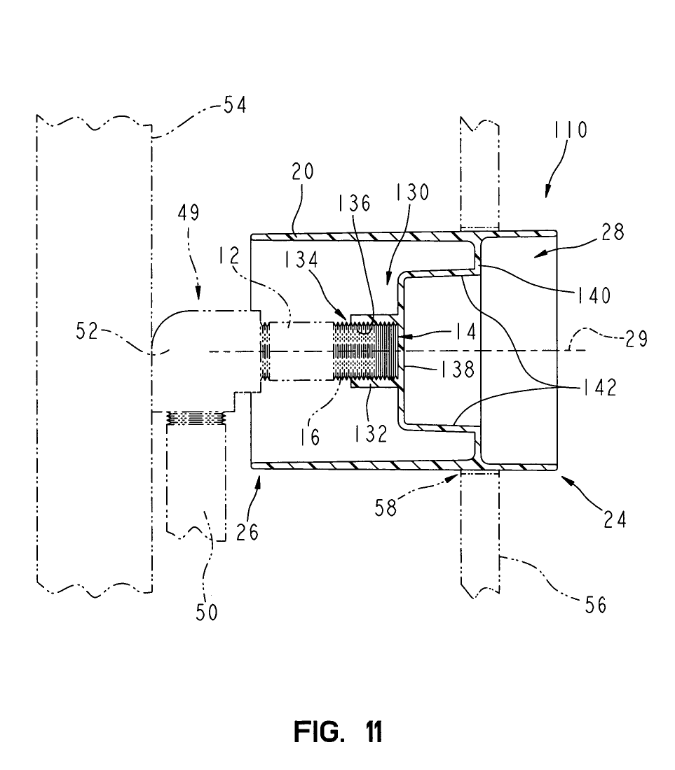

Turning now to FIGS. 7-10, a further illustrative embodiment plaster guard 110 includes many of the same structural components of the plaster guard 10 of FIGS. 1-6. As such, in the following description similar components will be identified with like reference numerals. The plaster guard 110 includes a coupler 130 having a receiving member 132. The receiving member 132 includes a receiving bore 134 including internal threads 136. The receiving member 132 includes an end wall 138 such that the receiving member may seal or cap the pipe nipple 12. A support member 140, illustratively an annular ring, supports the receiving member 132 concentrically within the central opening 28 of the body portion 20. A connecting member 142, illustratively having a cylindrical shape, couples the support member 140 to the receiving member 132.

As illustrated in FIG. 11, the receiving bore 134 is configured to threadably couple with the pipe nipple 12. More particularly, the internal threads 136 of the receiving bore 134 are defined to mate with the external threads 16 of the pipe nipple 12. As such, it is possible to produce a wide variety of different plaster guards 110, each having a configuration specifically adapted to cooperate with a pipe nipple 12 having a particular outer diameter and particular thread dimensions.

Use of the plaster guard 110 is substantially similar to the use of the plaster guard 10 as detailed above. However, the plaster guard 110 is coupled to the pipe nipple 12 by rotating the body portion 20 in a first direction and thereby threading the receiving member 132 of the plaster guard 110 onto the end 14 of the pipe nipple 12. Similarly, the plaster guard 110 is uncoupled from the pipe nipple 12 by rotating the body portion 20 in a second direction and thereby unthreading the receiving member 132 of the plaster guard 110 from the end 14 of the pipe nipple 12. As noted above, the end wall 138 of the plaster guard 110 seals or caps the end 14 of the pipe nipple 12, thereby eliminating the need for the separate end cap 18.

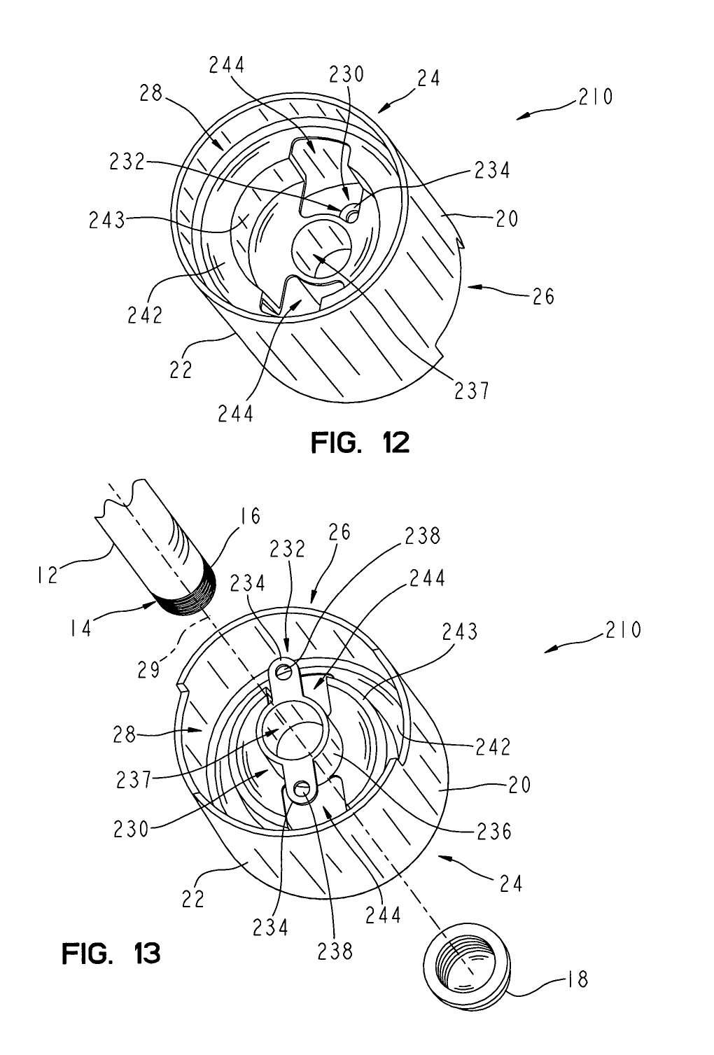

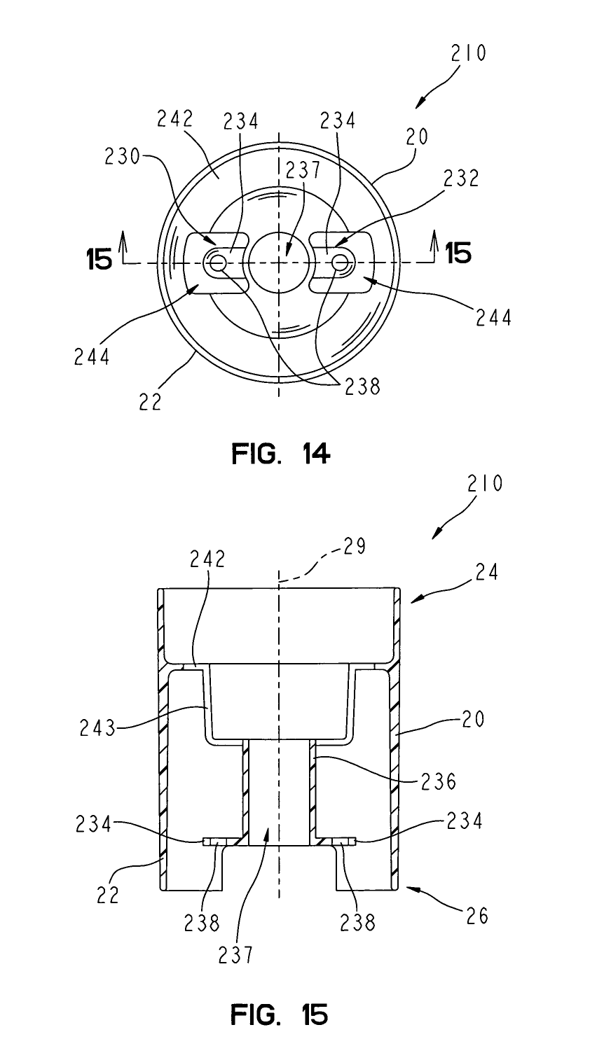

Referring now to FIGS. 12-15, a further illustrative embodiment of the plaster guard 210 includes many of the same components of the plaster guard 10 of FIGS. 1-6 and the plaster guard 110 of FIGS. 7-11. Again, in the following description like reference numbers will be used to refer to similar components.

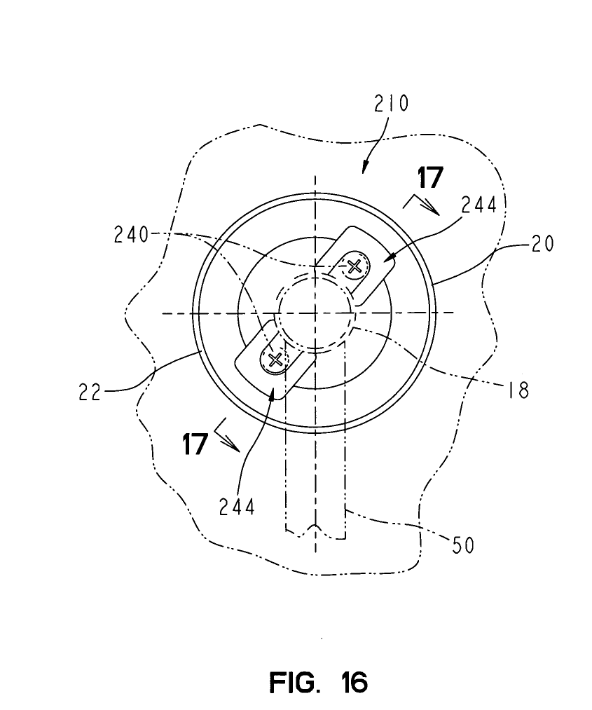

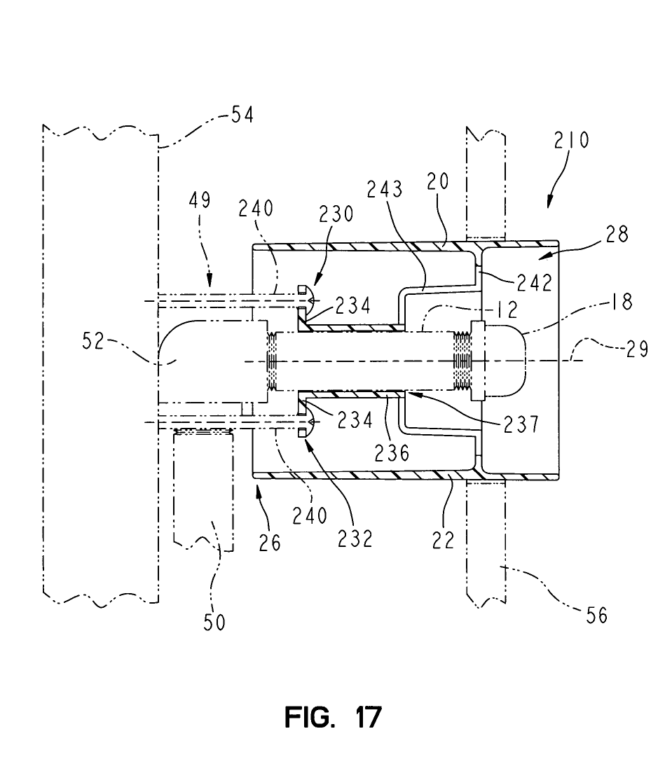

The plaster guard 210 includes a coupler 230 having a mounting bracket 232 supported proximate the rear end 26 of the outer wall 22. The mounting bracket 232 includes a pair of diametrically opposed mounting tabs 234. The mounting tabs 234 extend radially outwardly from a receiving member 236 having a receiving bore 237 configured to slidably receive the pipe nipple 12. Each mounting tab 234 includes a mounting aperture 238 configured to receive a fastener 240 (FIGS. 16 and 17), such as a conventional screw. A support member 242, illustratively an annular ring, supports the receiving member 236 within the outer wall 22. A connecting member 243, illustratively having a cylindrical shape, couples the support member 242 to the receiving member 236. A pair of access windows 244 are formed within the support member 242 and the connecting member 243 and are axially aligned with the mounting apertures 238 of the mounting tabs 234. Alignment of the access windows 244 with the mounting apertures 238 facilitates installation of the plaster guard 210, as detailed below.

Use of the plaster guard 210 is substantially similar to the use of the plaster guard 10 and plaster guard 110 as detailed above. However, the plaster guard 210 is coupled around the pipe nipple 12 by passing the body portion 20 over the pipe nipple 12 and then fixing the plaster guard 210 to the stringer 54. More particularly, the receiving member 236 is axially moved toward the pipe nipple 12, and the pipe nipple 12 is slidably received within the receiving bore 237. Next, the fasteners 240 are passed through the windows 244, through the mounting apertures 238 of the mounting tabs 234, and then inserted into the stringer 54. A tool (not shown), such as a screwdriver, may be inserted through each window 244 to facilitate securing of the fasteners 240 to the stringer 54. The plaster guard 210 is uncoupled from around the pipe nipple 12 by simply removing the fasteners 240 from the stringer 54.

Although the invention has been described in detail with reference to certain preferred embodiments, variations and modifications exist within the spirit and scope of the invention as described and defined in the following claims.

1. A plaster guard configured to define a recess within a wall around a pipe nipple, the plaster guard comprising:
a tubular body portion including an outer wall extending axially between a front end and a rear end and defining a central opening configured to receive the pipe nipple; and
a coupler supported by the outer wall and configured to removably support the body portion around the pipe nipple.

2. The plaster guard of claim 1, wherein the coupler includes a plurality of arms positioned radially inwardly from the outer wall, each arm including a retaining portion configured to engage a cap supported by an end of the pipe nipple and thereby prevent axial movement of the body portion in a direction from the rear end toward the front end.

3. The plaster guard of claim 2, wherein the retaining portion includes a stop surface facing axially toward the front end and an inclined guide surface facing toward the rear end, the inclined guide surface configured to be contacted by the cap of the pipe nipple and force the arms radially outwardly when the central opening receives the pipe nipple and the tubular body portion is moved axially in a direction from the front end toward the rear end.

4. The plaster guard of claim 2, further comprising a support lip positioned within the central opening and supporting the arms in spaced relation to the outer wall.

5. The plaster guard of claim 1, wherein the coupler includes a receiving member having an internally threaded receiving bore configured to couple to external threads supported on an end of the pipe nipple.

6. The plaster guard of claim 5, wherein the coupler further includes an end wall covering an end of the receiving bore and defining a cap for the pipe nipple.

7. The plaster guard of claim 1, wherein the coupler includes a mounting bracket supported by the outer wall and positioned proximate the rear end of the outer wall, the mounting bracket configured to be fixed to a stringer positioned behind the pipe nipple.

8. The plaster guard of claim 7, further comprising a receiving member defining a receiving bore configured to receive the pipe nipple, and a support member coupling the receiving member to the outer wall.

9. The plaster guard of claim 8, further comprising a mounting aperture formed within the mounting bracket, and an access window formed within the support member and aligned with mounting aperture.

10. A plaster guard configured to define a recess around a pipe nipple having an end cap supported thereon, the plaster guard comprising:
a cylindrical outer wall having a front end, a rear end, and an axially extending central opening;
a plurality of arms supported by the outer wall and extending within the central opening; and
wherein each arm includes a retaining portion configured to engage a rearwardly facing surface of the end cap and retain the outer wall on the pipe coupling, and a support portion coupling the retaining portion to the outer wall and positioning the retaining portion radially inwardly relative to the outer wall.

11. The plaster guard of claim 10, wherein the retaining portion includes a stop surface facing axially in a first direction and an inclined guide surface facing axially in a second direction substantially opposite the first direction, the including guide surface configured to be contacted by the cap of the pipe nipple and force the arms radially outwardly.

12. The plaster guard of claim 11, wherein the support portion biases the retaining portion radially inwardly.

13. The plaster guard of claim 10, further comprising a support lip positioned within the central opening and supporting the support portion of each arm in spaced relation to the outer wall.

14. The plaster guard of claim 10, wherein the retaining portions include arcuate notches which collectively define a substantially cylindrical receiving bore having a diameter greater than an outer diameter of the pipe and less than an outer diameter of the end cap.

15. A plaster guard configured to define a recess around a pipe nipple having an end supporting external threads, the plaster guard comprising:
a cylindrical outer wall defining a central opening;
a receiving member including an internally threaded receiving bore concentrically positioned within the central opening, the receiving bore configured to couple with the external threads of the pipe nipple; and
a support member coupling the receiving member to the outer wall.

16. The plaster guard of claim 15, wherein the receiving member further includes an end wall covering an end of the receiving bore and defining a cap for the pipe nipple.

17. The plaster guard of claim 15, wherein the support member comprises an annular ring concentrically received within the central opening intermediate the outer wall and the receiving member.

18. A plaster guard configured to define a recess around a pipe nipple, the plaster guard comprising:
a cylindrical outer wall extending axially between a front end and a rear end and defining a central opening;
a receiving member including a receiving bore concentrically received within the central opening, the receiving bore configured to receive the pipe coupling;
a mounting bracket supported by the outer wall and positioned proximate the rear end of the outer wall, the mounting bracket configured to be fixed to a stringer positioned behind the pipe nipple; and
a support member coupling the receiving member to the outer wall.

19. The plaster guard of claim 18, wherein the mounting bracket includes at least one tab having a mounting aperture and positioned radially intermediate the outer wall and the receiving member.

20. The plaster guard of claim 19, wherein the at least one tab is coupled to the receiving member and extends radially outwardly from the receiving member.

21. The plaster guard of claim 19, wherein the support member comprises an annular ring concentrically received within the central opening intermediate the outer wall and the receiving member.

22. The plaster guard of claim 21, wherein the annular ring includes at least one access window axially aligned with the mounting aperture of the at least one tab.

23. A method of forming a recess within a wall surrounding a pipe nipple, the method comprising the steps of:
providing a pipe nipple having an end and a longitudinal axis;
coupling a plaster guard around to the pipe nipple;
finishing a wall around the plaster guard; and
uncoupling the plaster guard from around the pipe nipple.

24. The method of claim 23, further comprising, prior to the coupling step, the steps of:
substantially aligning a plaster guard about the longitudinal axis of the pipe nipple; and
moving the plaster guard axially in a direction toward the pipe nipple.

25. The method of claim 22, further comprising the step of moving the plaster guard axially in a direction away from the pipe nipple, thereby forming a receiving recess within the wall.

26. The method of claim 25, further comprising the steps of inserting a fluid delivery device within the receiving recess and coupling the fluid delivery device to the pipe nipple.

27. The method of claim 26, wherein the fluid delivery device comprises a spray head supported by a swivel mount.

28. The method of claim 23, further comprising the steps of placing an end cap on the exposed threaded end of the pipe nipple, providing the plaster guard with retaining portions, and wherein the coupling step comprises biasing the retaining portions outwardly away from the end cap as the plaster guard is moved axially toward the pipe nipple until the retaining portions pass over the end cap.

29. The method of claim 28, wherein the retaining portions include inclined surfaces configured to bias the retaining portions away from the end cap as the plaster guard moves axially toward the pipe nipple and the end cap contacts the inclined surfaces.

30. The method of claim 28, wherein the uncoupling step comprises biasing the retaining portions outwardly away from the end cap as the plaster guard is moved axially away from the pipe nipple until the retaining portions pass over the end cap.

31. The method of claim 23, wherein the coupling step comprises providing the plaster guard with a receiving member including an internally threaded bore, and threading the threaded end of the pipe nipple into the threaded bore.

32. The method of claim 23, wherein the coupling step comprises providing the plaster guard with a mounting bracket, and securing the mounting bracket to a stringer supported adjacent the pipe nipple.
